(19) United States
(12) Patent Application Publication
(10) Pub. No.: US 2018/0127537 A1
(43) Pub. Date: May 10, 2018

(54) RESINS AND COMPOSITIONS FOR HIGH TEMPERATURE APPLICATIONS

(71) Applicant: HENKEL IP & HOLDING GMBH, Duesseldorf (DE)

(72) Inventor: Puwei Liu, Glastonbury, CT (US)

(21) Appl. No.: 15/626,503

(22) Filed: Jun. 19, 2017

Related U.S. Application Data
(63) Continuation of application No. PCT/US2015/063652, filed on Dec. 3, 2015.
(60) Provisional application No. 62/094,740, filed on Dec. 19, 2014.

(51) Int. Cl. C08G 59/24; C08F 122/00; C08F 120/00; C08G 73/22; C09J 11/04; C09J 163/00; C08G 59/56; C08G 59/50; C09J 9/00

(52) U.S. Cl. CPC C08G 59/245; C08F 122/00; C08F 120/00; C08G 73/22; C09J 9/00; C09J 163/00; C08G 59/56; C08G 59/5073; C09J 11/04

(57) ABSTRACT

In accordance with the present invention, there are provided methods to improve the performance properties of thermoset polymer resins prepared by the activation of one or more reactive monomer(s) which is(are) initiated by way of a first reaction mechanism at a defined temperature (typically a temperature in the range of 40-200° C.). Exemplary performance properties which are improved by the invention methods include enhanced thermal stability, tensile strength (which is maintained in spite of exposure to elevated temperatures over extended periods of time), adhesive properties (which are substantially maintained in spite of exposure to elevated temperatures over extended periods of time), weight loss (which is minimized in spite of exposure to elevated temperatures over extended periods of time), dielectric strength (which is substantially maintained in spite of exposure to elevated temperatures over extended periods of time), and the like.

### FIELD OF THE INVENTION

The present invention relates to methods to improve the performance properties of thermoset resin materials upon exposure to elevated temperatures over extended periods of time. In one aspect, the invention relates to methods to improve the thermal stability of thermoset resin materials upon exposure to elevated temperatures over extended periods of time. In another aspect, the invention relates to methods to maintain the tensile strength of thermoset resin materials upon exposure to elevated temperatures over extended periods of time. In yet another aspect, the invention relates to methods to maintain the adhesive properties of thermoset resin materials upon exposure to elevated temperatures over extended periods of time. In still another aspect, the invention relates to methods to minimize weight loss of thermoset resin materials upon exposure to elevated temperatures over extended periods of time. In a further aspect, the invention relates to methods to maintain a substantially constant weight in thermoset resin materials upon exposure to elevated temperatures over extended periods of time. In a still further aspect, the invention relates to methods to maintain the dielectric strength of thermoset resin materials upon exposure to elevated temperatures over extended periods of time. In still another aspect, the invention relates to methods to improve the thermal cycle performance of thermoset resin materials upon exposure to elevated temperatures over extended periods of time. In yet another aspect, the invention relates to thermoset resin materials which are thermally stable to exposure to elevated temperatures over extended periods of time.

### BACKGROUND OF THE INVENTION

Many resins commonly employed for adhesive and composite applications (for example, epoxies and acrylates), can only withstand exposure to temperatures up to about 200° C. when exposed over an extended period of time (e.g., 1000 hours). Above such temperatures, however, most normally used polymer systems will gradually break down and the physical properties thereof will be compromised.

Since such polymer systems are widely used, readily available and cost effective, methods to improve the performance properties thereof, especially upon exposure to elevated temperatures over extended periods of time, would be useful.

### SUMMARY OF THE INVENTION

In accordance with one aspect of the present invention, there are provided methods to improve the performance properties of thermoset polymer resin-containing systems, wherein said polymer resins are prepared by the activation of one or more reactive monomer(s) which is(are) initiated by way of a first reaction mechanism at a defined temperature (typically a temperature in the range of 40-200° C.). Exemplary performance properties which are improved by the invention methods include enhanced thermal stability, tensile strength (which is maintained in spite of exposure to elevated temperatures over extended periods of time), adhesive properties (which are substantially maintained in spite of exposure to elevated temperatures over extended periods of time), weight loss (which is minimized in spite of exposure to elevated temperatures over extended periods of time), dielectric strength (which is substantially maintained in spite of exposure to elevated temperatures over extended periods of time), thermal cycle performance of thermoset resin materials (which is improved upon exposure to elevated temperatures over extended periods of time), and the like.

Invention methods comprise employing as at least a portion of said reactive monomer(s) one or more reactive monomer(s) which is(are) initiated by way of two distinct curing mechanisms, i.e., both by way of the first reaction mechanism referred to above, and by way of a second reaction mechanism that does not reach substantial levels of activation until the resin is exposed to an elevated temperature (i.e., a temperature greater than 200° C.).

In accordance with another aspect of the current invention, there are provided thermally stable thermoset polymer resins comprising a cured combination of:
one or more reactive monomer(s) which is(are) initiated by way of a first reaction mechanism at a temperature in the range of 40-200° C., and
one or more reactive monomer(s) which is(are) initiated both by way of said first reaction mechanism and by way of a second reaction mechanism that does not reach substantial levels of activation until said resin is exposed to an elevated temperature.

### BRIEF DESCRIPTION OF THE FIGURES

FIG. 1 shows the ability of formulations according to the present invention to retain the tensile strength thereof. Whereas the control formulation (with no added component capable of curing by an alternate high temperature curing process) shows substantial loss of tensile strength (see the lowest curve on the figure), the addition of a mere 20 wt % of a component capable of curing by an alternate high temperature curing process shows substantial reduction in loss of tensile strength (see the penultimate curve on the figure).

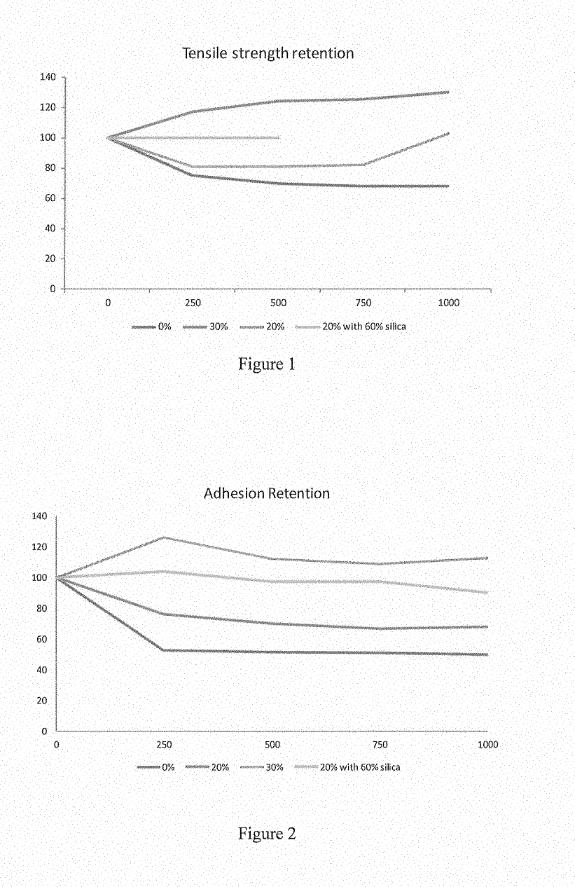

Increasing the amount of the component capable of curing by an alternate high temperature curing process to 30 wt % shows substantial improvement in tensile strength (see the top curve of the figure).

This positive effect on tensile strength is also seen with filled resins; see the second curve on the figure, which shows that a filled resin with 20 wt % of a component capable of curing by an alternate high temperature curing process shows excellent stability.

Similarly, FIG. 2 shows the ability of formulations according to the present invention to retain the adhesion thereof. Whereas the control formulation (with no added component capable of curing by an alternate high temperature curing process) shows substantial loss of adhesion (see the lowest curve of the figure), the addition of a mere 20 wt % of a component capable of curing by an alternate high temperature curing process) shows substantial reduction in loss of adhesive properties (see the penultimate curve of the figure).

Increasing the amount of the component capable of curing by an alternate high temperature curing process to 30 wt % shows substantial improvement in adhesion retention (see the top curve of the figure).

This positive effect on tensile strength is also seen with filled resins; see the second curve of the figure, which shows that a filled resin with 20 wt % of a component capable of curing by an alternate high temperature curing process maintains substantially all of its adhesive properties.

### DETAILED DESCRIPTION OF THE INVENTION

In accordance with the present invention, there are provided methods to improve the thermal stability of thermoset polymer resin-containing systems, wherein said polymer resins are prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

In some embodiments, the elevated temperature to which resins are exposed comprise a temperature greater than 200° C.; in some embodiments, the elevated temperature to which resins are exposed comprise a temperature greater than 210° C.; in some embodiments, the elevated temperature to which resins are exposed comprise a temperature greater than 220° C.; in some embodiments, the elevated temperature to which resins are exposed comprise a temperature greater than 230° C.; in some embodiments, the elevated temperature to which resins are exposed comprise a temperature greater than 240° C.; in some embodiments, the elevated temperature to which resins are exposed comprise a temperature greater than 250° C.; in some embodiments, the elevated temperature to which resins are exposed comprise a temperature greater than 260° C.; in some embodiments, the elevated temperature to which resins are exposed comprise a temperature greater than 280° C.; in some embodiments, the elevated temperature to which resins are exposed comprise a temperature greater than 300° C.

In some embodiments, the first reaction mechanism contemplated for curing reactive monomer(s) is initiated at a temperature in the range of 40-200° C.; in some embodiments, the first reaction mechanism is initiated at a temperature in the range of 50-200° C.; in some embodiments, the first reaction mechanism is initated at a temperature in the range of 60-200° C.; in some embodiments, the first reaction mechanism is initiated at a temperature in the range of 70-200° C.; in some embodiments, the first reaction mechanism is initiated at a temperature in the range of 80-200° C.; in some embodiments, the first reaction mechanism is initiated at a temperature in the range of 90-200° C.; in some embodiments, the first reaction mechanism is initiated at a temperature in the range of 100-200° C.; in some embodiments, the first reaction mechanism is initated at a temperature in the range of 40-210° C.; in some embodiments, the first reaction mechanism is initiated at a temperature in the range of 50-210° C.; in some embodiments, the first reaction mechanism is initiated at a temperature in the range of 60-210° C.; in some embodiments, the first reaction mechanism is initiated at a temperature in the range of 70-210° C.; in some embodiments, the first reaction mechanism is initiated at a temperature in the range of 80-210° C.; in some embodiments, the first reaction mechanism is initated at a temperature in the range of 90-210° C.; in some embodiments, the first reaction mechanism is initiated at a temperature in the range of 100-210° C.; in some embodiments, the first reaction mechanism is initiated at a temperature in the range of 40-220° C.; in some embodiments, the first reaction mechanism is initiated at a temperature in the range of 50-220° C.; in some embodiments, the first reaction mechanism is initiated at a temperature in the range of 60-220° C.; in some embodiments, the first reaction mechanism is initated at a temperature in the range of 70-220° C.; in some embodiments, the first reaction mechanism is initiated at a temperature in the range of 80-220° C.; in some embodiments, the first reaction mechanism is initiated at a temperature in the range of 90-220° C.; in some embodiments, the first reaction mechanism is initiated at a temperature in the range of 100-220° C.; in some embodiments, the first reaction mechanism is initiated at a temperature in the range of 40-230° C.; in some embodiments, the first reaction mechanism is initated at a temperature in the range of 50-230° C.; in some embodiments, the first reaction mechanism is initiated at a temperature in the range of 60-230° C.; in some embodiments, the first reaction mechanism is initiated at a temperature in the range of 70-230° C.; in some embodiments, the first reaction mechanism is initiated at a temperature in the range of 80-230° C.; in some embodiments, the first reaction mechanism is initiated at a temperature in the range of 90-230° C.; in some embodiments, the first reaction mechanism is initated at a temperature in the range of 100-230° C.; in some embodiments, the first reaction mechanism is initiated at a temperature in the range of 40-240° C.; in some embodiments, the first reaction mechanism is initiated at a temperature in the range of 50-240° C.; in some embodiments, the first reaction mechanism is initiated at a temperature in the range of 60-240° C.; in some embodiments, the first reaction mechanism is initiated at a temperature in the range of 70-240° C.; in some embodiments, the first reaction mechanism is initated at a temperature in the range of 80-240° C.; in some embodiments, the first reaction mechanism is initiated at a temperature in the range of 90-240° C.; in some embodiments, the first reaction mechanism is initiated at a temperature in the range of 100-240° C.

In some embodiments, the second reaction mechanism does not reach substantial levels of activation until said resin is exposed to an elevated temperature greater than 200° C.; in some embodiments, the second reaction mechanism does not reach substantial levels of activation until said resin is exposed to an elevated temperature greater than 210° C.; in some embodiments, the second reaction mechanism does not reach substantial levels of activation until said resin is exposed to an elevated temperature elevated temperature greater than 220° C.; in some embodiments, the second reaction mechanism does not reach substantial levels of activation until said resin is exposed to an elevated temperature greater than 230° C.; in some embodiments, the second reaction mechanism does not reach substantial levels of activation until said resin is exposed to an elevated temperature greater than 240° C.; in some embodiments, the second reaction mechanism does not reach substantial levels of activation until said resin is exposed to an elevated temperature greater than 250° C.; in some embodiments, the second reaction mechanism does not reach substantial levels of activation until said resin is exposed to an elevated temperature elevated temperature greater than 260° C.; in some embodiments, the second reaction mechanism does not reach substantial levels of activation until said resin is exposed to an elevated temperature greater than 270° C.; in some embodiments, the second reaction mechanism does not reach substantial levels of activation until said resin is exposed to an elevated temperature greater than 280° C.; in some embodiments, the second reaction mechanism does not reach substantial levels of activation until said resin is exposed to an elevated temperature greater than 290° C.; in some embodiments, the second reaction mechanism does not reach substantial levels of activation until said resin is exposed to an elevated temperature elevated temperature greater than 300° C.

As contemplated herein, exposure of thermoset resin materials to elevated temperatures over extended periods of time embraces exposure to such conditions for at least 100 hours; in some embodiments, exposure of thermoset resin materials to elevated temperatures over extended periods of time embraces exposure to such conditions for at least 200 hours; in some embodiments, exposure of thermoset resin materials to elevated temperatures over extended periods of time embraces exposure to such conditions for at least 300 hours; in some embodiments, exposure of thermoset resin materials to elevated temperatures over extended periods of time embraces exposure to such conditions for at least 400 hours; in some embodiments, exposure of thermoset resin materials to elevated temperatures over extended periods of time embraces exposure to such conditions for at least 500 hours; in some embodiments, exposure of thermoset resin materials to elevated temperatures over extended periods of time embraces exposure to such conditions for at least 600 hours; in some embodiments, exposure of thermoset resin materials to elevated temperatures over extended periods of time embraces exposure to such conditions for at least 700 hours; in some embodiments, exposure of thermoset resin materials to elevated temperatures over extended periods of time embraces exposure to such conditions for at least 800 hours; in some embodiments, exposure of thermoset resin materials to elevated temperatures over extended periods of time embraces exposure to such conditions for at least 900 hours; in some embodiments, exposure of thermoset resin materials to elevated temperatures over extended periods of time embraces exposure to such conditions for at least 1000 hours.

In some aspects, the one or more reactive monomer(s) which is(are) initiated by way of a first reaction mechanism at a temperature in the range of 40-200° C. is selected from compounds having one or more aromatic epoxy groups thereon, one or more benzoxazine groups thereon, one or more aromatic acrylate groups thereon, one or more aromatic cyanate ester groups thereon, one or more aromatic bismaleimide (BMI) groups thereon, one or more aromatic itaconamide groups thereon, one or more aromatic nadimide groups thereon, one or more aromatic ester groups thereon, one or more aromatic olefin groups thereon, one or more aromatic alkyne groups thereon, or one or more aromatic nitrile groups thereon, and the like, as well as compounds having combinations of any two or more of said reactive groups thereon, or combinations of any two or more of said reactive monomers.

In some aspects, the one or more reactive monomer(s) which is(are) initiated by way of a first reaction mechanism at a temperature in the range of 40-200° C. is a compound having one or more aromatic epoxy groups thereon.

In some aspects, the one or more reactive monomer(s) which do not reach substantial levels of activation until said resin is exposed to an elevated temperature are selected from compounds having one or more aromatic olefin groups thereon, one or more aromatic alkyne groups thereon, or one or more aromatic nitrile groups thereon, and the like. In some aspects, the one or more reactive monomer(s) which do not reach substantial levels of activation until said resin is exposed to an elevated temperature is a compound having one or more aromatic olefin groups thereon.

Exemplary epoxy monomers contemplated for use in the practice of the present invention include reactive monomers or oligomers of reaction products of aromatic phenols and epichlorohydrin, examples of which include liquid-type epoxies based on bisphenol A, solid-type epoxies based on bisphenol A, liquid-type epoxies based on bisphenol F (e.g., Epiclon EXA-835LV), multifunctional epoxies based on phenolic resins, dicyclopentadiene-type epoxies (e.g., Epiclon HP-7200L), naphthalene-type epoxies, and the like, as well as mixtures of any two or more thereof.

Additional exemplary epoxy monomers contemplated for use herein include diepoxides of the cycloaliphatic alcohol, hydrogenated bisphenol A (commercially available as Epalloy 5000), difunctional cycloaliphatic glycidyl esters of hexahydrophthallic anhydride (commercially available as Epalloy 5200), Epiclon EXA-835LV, Epiclon HP-7200L, and the like, as well as mixtures of any two or more thereof.

When epoxy monomer(s) are present in invention compositions, the resulting formulation comprises in the range of about 0.5-20 wt % of said epoxy. In certain embodiments, the resulting formulation comprises in the range of about 2-10 wt % of said epoxy.

When epoxy monomer(s) are present in invention formulations, an epoxy cure agent is also present. Exemplary epoxy cure agents include ureas, aliphatic and aromatic amines, amine hardeners, polyamides, imidazoles, dicyandiamides, hydrazides, urea-amine hybrid curing systems, free radical initiators (e.g., peroxy esters, peroxy carbonates, hydroperoxides, alkylperoxides, arylperoxides, azo compounds, and the like), organic bases, transition metal catalysts, phenols, acid anhydrides, Lewis acids, and Lewis bases.

When present, invention compositions comprise in the range of about 0.1-20 wt % of said epoxy cure agent. In certain embodiments, invention compositions comprise in the range of about 0.5-10 wt % of epoxy cure agent.

Epoxy components contemplated for use herein may include the combination of two or more different bisphenol based epoxies. These bisphenol based epoxies may be selected from bisphenol A, bisphenol F, or bisphenol S epoxies, or combinations thereof. In addition, two or more different bisphenol epoxies within the same type of resin (such A, F or S) may be used.

Commercially available examples of the bisphenol epoxies desirable for use herein include bisphenol-F-type epoxies (such as RE-404-S from Nippon Kayaku, Japan, and EPICLON 830 (RE1801), 830S (RE1815), 830A (RE1826) and 830 W from Dai Nippon Ink & Chemicals, Inc., and RSL 1738 and YL-983U from Resolution) and bisphenol-A-type epoxies (such as YL-979 and 980 from Resolution).

The bisphenol epoxies available commercially from Dai Nippon and noted above are promoted as liquid undiluted epichlorohydrin-bisphenol F epoxies having much lower viscosities than conventional epoxies based on bisphenol A epoxies and have physical properties similar to liquid bisphenol A epoxies. Bisphenol F epoxy has lower viscosity than bisphenol A epoxies, all else being the same between the two types of epoxies, which affords a lower viscosity and thus a fast flow underfill sealant material. The EEW of these four bisphenol F epoxies is between 165 and 180. The viscosity at 25° C. is between 3,000 and 4,500 cps (except for RE1801 whose upper viscosity limit is 4,000 cps). The hydrolyzable chloride content is reported as 200 ppm for RE1815 and 830 W, and that for RE1826 as 100 ppm.

The bisphenol epoxies available commercially from Resolution and noted above are promoted as low chloride containing liquid epoxies. The bisphenol A epoxies have a EEW (g/eq) of between 180 and 195 and a viscosity at 25° C. of between 100 and 250 cps. The total chloride content for YL-979 is reported as between 500 and 700 ppm, and that for YL-980 as between 100 and 300 ppm. The bisphenol F epoxies have a EEW (g/eq) of between 165 and 180 and a viscosity at 25° C. of between 30 and 60. The total chloride content for RSL-1738 is reported as between 500 and 700 ppm, and that for YL-983U as between 150 and 350 ppm.

In addition to the bisphenol epoxies, other epoxy compounds are included within the epoxy component of the present invention. For instance, cycloaliphatic epoxies, such as 3,4-epoxycyclohexylmethyl-3,4-epoxycyclohexylcarbonate, are used. Also monofunctional, difunctional or multifunctional reactive diluents to adjust the viscosity and/or lower the Tg are also used, such as butyl glycidyl ether, cresyl glycidyl ether, polyethylene glycol glycidyl ether or polypropylene glycol glycidyl ether.

Among the epoxies suitable for use herein also include polyglycidyl derivatives of phenolic compounds, such as those available commercially under the tradename EPON, such as EPON 828, EPON 1001, EPON 1009, and EPON 1031 from Resolution; DER 331, DER 332, DER 334, and DER 542 from Dow Chemical Co.; and BREN-S from Nippon Kayaku. Other suitable epoxies include polyepoxides prepared from polyols and the like and polyglycidyl derivatives of phenol-formaldehyde novolacs, the latter of such as DEN 431, DEN 438, and DEN 439 from Dow Chemical. Cresol analogs are also available commercially under the tradename ARALDITE, such as ARALDITE ECN 1235, ARALDITE ECN 1273, and ARALDITE ECN 1299 from Ciba Specialty Chemicals Corporation. SU-8 is a bisphenol-A-type epoxy novolac available from Resolution. Polyglycidyl adducts of amines, aminoalcohols and polycarboxylic acids are also useful in this invention, commercially available resins of which include GLYAMINE 135, GLYAMINE 125, and GLYAM1NE 115 from F.I.C. Corporation; ARALDITE MY-720, ARALDITE 0500, and ARALDITE 0510 from Ciba Specialty Chemicals and PGA-X and PGA-C from the Sherwin-Williams Co.

Appropriate monofunctional epoxy coreactant diluents for use herein include those that have a viscosity which is lower than that of the epoxy component, ordinarily, less than about 250 cps.

The monofunctional epoxy coreactant diluents should have an epoxy group with an alkyl group of about 6 to about 28 carbon atoms, examples of which include C₆₋₂₈ alkyl glycidyl ethers, C₆₋₂₈ fatty acid glycidyl esters and C₆₋₂₈ alkylphenol glycidyl ethers.

In the event such a monofunctional epoxy coreactant diluent is included, such coreactant diluent should be employed in an amount of up to about 5 percent by weight to about 15 percent by weight, such as about 8 percent by weight to about 12 percent by weight, based on the total weight of the composition.

The epoxy component should be present in the composition in an amount which the range of about 10 percent by weight to about 95 percent by weight, desirably about 20 percent by weight to about 80 percent by weight, such as about 60 percent by weight.

In some embodiments, the epoxy component employed herein is a silane modified epoxy, e.g., a composition of matter that includes:

(A) an epoxy component embraced by the following structure:

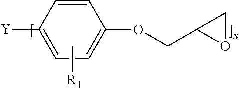

where:
Y may or may not be present and when Y present is a direct bond, CH₂, CH(CH₃)₂, C═O, or S,
R₁ here is alkyl, alkenyl, hydroxy, carboxy and halogen, and
x here is 1-4;
   (B) an epoxy-functionalized alkoxy silane embraced by the following structure:

R¹—Si(OR²)₃

where:
R¹ is an oxirane-containing moiety and
R² is an alkyl or alkoxy-substituted alkyl, aryl, or aralkyl group having from one to ten carbon atoms; and
   (C) reaction products of components (A) and (B).

An example of one such silane-modified epoxy is formed as the reaction product of an aromatic epoxy, such as a bisphenol A, E, F or S epoxy or biphenyl epoxy, and epoxy silane where the epoxy silane is embraced by the following structure:

R¹—Si(OR²)₃

where:
R¹ is an oxirane-containing moiety, examples of which include 2-(ethoxymethyl)oxirane, 2-(propoxymethyl)oxirane, 2-(methoxymethyl)oxirane, and 2-(3-methoxypropyl)oxirane and
R² is an alkyl or alkoxy-substituted alkyl, aryl, or aralkyl group having from one to ten carbon atoms. In one embodiment, R¹ is 2-(ethoxymethyl)oxirane and R² is methyl.

Idealized structures of the aromatic epoxy used to prepare the silane modified epoxy include

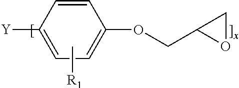

where:
Y may or may not be present and when Y present is a direct bond, CH₂, CH(CH₃)₂, C═O, or S,
R₁ here is alkyl, alkenyl, hydroxy, carboxy and halogen, and
x here is 1-4.
   Of course, when x is 2-4, chain extended versions of the aromatic epoxy are also contemplated as being embraced by this structure.

For instance, a chain extended version of the aromatic epoxy may be embraced by the structure below

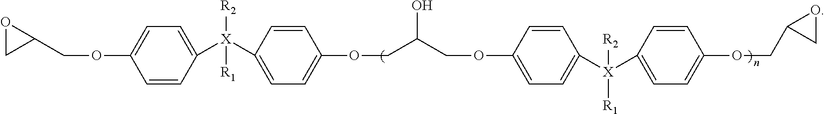

The silane modified epoxy may also be a combination of the aromatic epoxy, the epoxy silane, and reaction products of the aromatic epoxy and the epoxy silane. The reaction products may be prepared from the aromatic epoxy and epoxy silane in a by weight ratio of 1:100 to 100:1, such as a by weight ratio of 1:10 to 10:1.

Exemplary acrylates contemplated for use herein include monofunctional (meth)acrylates, difunctional (meth)acrylates, trifunctional (meth)acrylates, polyfunctional (meth)acrylates, and the like.

Exemplary monofunctional (meth)acrylates include phenylphenol acrylate, methoxypolyethylene acrylate, acryloyloxyethyl succinate, fatty acid acrylate, methacryloyloxyethylphthalic acid, phenoxyethylene glycol methacrylate, fatty acid methacrylate, β-carboxyethyl acrylate, isobornyl acrylate, isobutyl acrylate, t-butyl acrylate, hydroxyethyl acrylate, hydroxypropyl acrylate, dihydrocyclopentadiethyl acrylate, cyclohexyl methacrylate, t-butyl methacrylate, dimethylaminoethyl methacrylate, diethylaminoethyl methacrylate, t-butylaminoethyl methacrylate, 4-hydroxybutyl acrylate, tetrahydrofurfuryl acrylate, benzyl acrylate, ethylcarbitol acrylate, phenoxyethyl acrylate, methoxytriethylene glycol acrylate, monopentaerythritol acrylate, dipentaerythritol acrylate, tripentaerythritol acrylate, polypentaerythritol acrylate and the like.

Exemplary difunctional (meth)acrylates include hexanediol dimethacrylate, hydroxyacryloyloxypropyl methacrylate, hexanediol diacrylate, urethane acrylate, epoxyacrylate, bisphenol A-type epoxyacrylate, modified epoxyacrylate, fatty acid-modified epoxyacrylate, amine-modified bisphenol A-type epoxyacrylate, allyl methacrylate, ethylene glycol dimethacrylate, diethylene glycol dimethacrylate, ethoxylated bisphenol A dimethacrylate, tricyclodecanedimethanol dimethacrylate, glycerin dimethacrylate, polypropylene glycol diacrylate, propoxylated ethoxylated bisphenol A diacrylate, 9,9-bis(4-(2-acryloyloxyethoxy)phenyl) fluorene, tricyclodecane diacrylate, dipropylene glycol diacrylate, polypropylene glycol diacrylate, PO-modified neopentyl glycol diacrylate, tricyclodecanedimethanol diacrylate, 1,12-dodecanediol dimethacrylate, and the like.

Exemplary trifunctional (meth)acrylates include trimethylolpropane trimethacrylate, trimethylolpropane triacrylate, trimethylolpropane ethoxy triacrylate, polyether triacrylate, glycerin propoxy triacrylate, and the like.

Exemplary polyfunctional (meth)acrylates include dipentaerythritol polyacrylate, dipentaerythritol hexaacrylate, pentaerythritol tetraacrylate, pentaerythritolethoxy tetraacrylate, ditrimethylolpropane tetraacrylate, and the like.

Additional exemplary acrylates contemplated for use in the practice of the present invention include those described in U.S. Pat. No. 5,717,034, the entire contents of which are hereby incorporated by reference herein.

Exemplary compounds having one or more benzoxazine groups thereon contemplated for use herein have the structure:

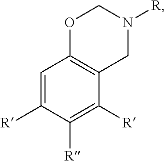

wherein:
R, R′ and R″ are each independently selected from hydrogen, substituted or unsubstituted alkyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl, as well as combinations of any two or more thereof.

Exemplary compounds having one or more cyanate ester groups thereon contemplated for use herein are aryl compounds having at least one cyanate ester group on each molecule and may be generally represented by the formula:

Ar(OCN)ₘ,

where:
m is an integer from 2 to 5 and
Ar is an aromatic radical.
   In some embodiments, the aromatic radical Ar contains at least 6 carbon atoms, and may be derived, for example, from aromatic hydrocarbons, such as benzene, biphenyl, naphthalene, anthracene, pyrene, or the like.

In some embodiments, the aromatic radical Ar is derived from a polynuclear aromatic hydrocarbon in which at least two aromatic rings are attached to each other through a bridging group. In some embodiments, the aromatic radicals are derived from novolac-type phenolic resins—i.e., cyanate esters of these phenolic resins. The aromatic radical Ar may also contain further ring-attached, non-reactive substituents.

Exemplary cyanate esters include 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene or cyanated bisphenol-terminated polycarbonate or other thermoplastic oligomer.

Specific cyanate esters contemplated for use herein include AROCY 366 (1,3-bis[4-cyanatophenyl-1-(methylethylidene)]benzene),

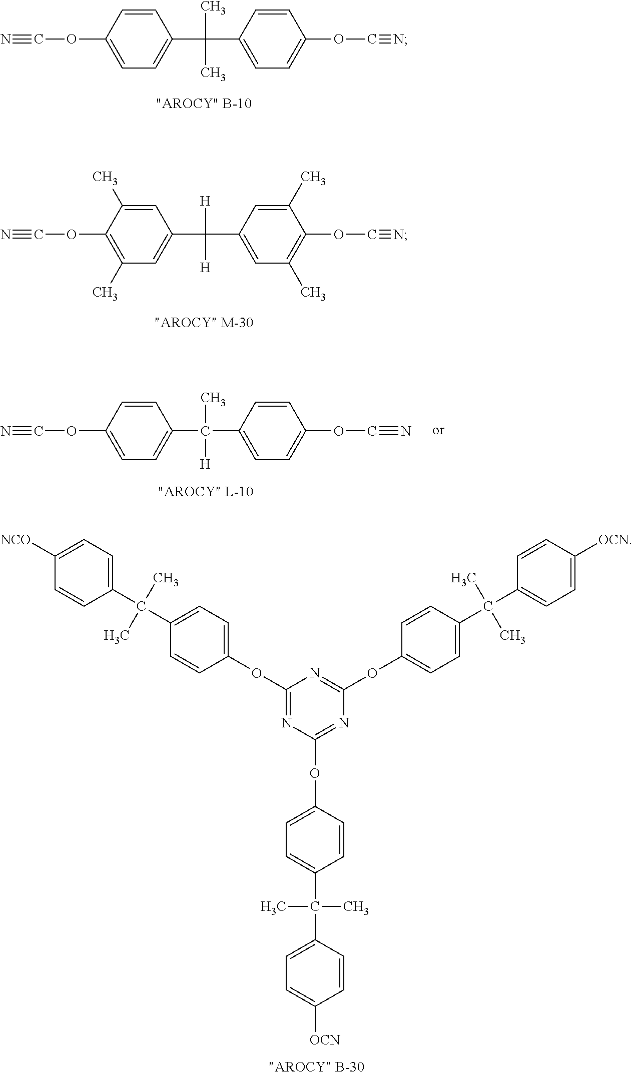

Other cyanate esters include cyanates disclosed in U.S. Pat. Nos. 4,477,629 and 4,528,366, the disclosure of each of which is hereby expressly incorporated herein by reference; the cyanate esters disclosed in U.K. Pat. No. 1,305,702, and the cyanate esters disclosed in International Patent Publication WO 85/02184, the disclosure of each of which is hereby expressly incorporated herein by reference.

Bismaleimides (BMI), itaconamides or nadimides contemplated for use herein have the structure:

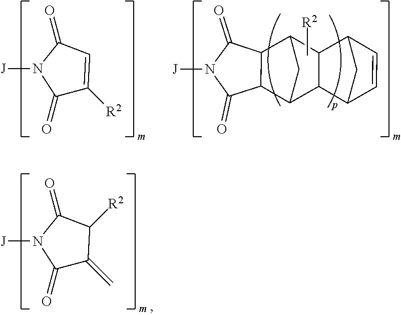

respectively, wherein:
m is 1-15,
p is 0-15,
each R² is independently selected from hydrogen or lower alkyl (such as C₁₋₅), and
J is a monovalent or a polyvalent radical comprising organic or organosiloxane radicals, and
combinations of any two or more thereof.

In some embodiments, J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as
   combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

In some embodiments, J is oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl. oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, amino arylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

In some embodiments, esters contemplated for use herein are monobasic (e.g., ethyl acetate, butyl acetate, methoxy propyl acetate, and the like); dibasic ester (e.g., alpha-terpineol, beta-terpineol, kerosene, dibutylphthalate, butyl carbitol, butyl carbitol acetate, carbitol acetate, ethyl carbitol acetate, hexylene glycol, or an ester of a high boiling alcohol (e.g, an alcohol having a boiling point >100° C.; alternatively, an alcohol having at least a 4 carbon backbone may also be considered to be a “high boiling alcohol”.

In some embodiments, compounds having one or more olefin groups thereon contemplated for use herein have the structure:

R¹(R²)C═CR³(R⁴)

wherein each of R¹, R², R³ and R⁴ are independently hydrogen, substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

In some embodiments, the olefin is ethylene, propylene, 1-butene, 1-hexene, 3-methyl-1-pentene, 4-methyl-1-pentene, and the like, as well as a polymerizable hydrophobic aromatic hydrocarbon such as styrene.

In some embodiments, compounds having one or more nitrile groups thereon contemplated for use herein have the structure:

R¹C≡N

wherein R¹ is substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

In some embodiments, the nitrile is ethylnitrile, propylnitrile, butyl nitrile, hexyl nitrile, 3-methyl-1-pentyl nitrile, 4-methyl-1-pentyl nitrile, and the like.

In some embodiments, compounds having one or more alkyne groups thereon contemplated for use herein have the structure:

R¹C≡CR³

wherein each of R¹ and R³ are independently hydrogen, substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

In some embodiments, the alkyne is ethyne, propyne, 1-butyne, 1-hexyne, 3-methyl-1-pentyne, 4-methyl-1-pentyne, and the like.

In some embodiments, reactive monomer(s) which is(are) initiated both by way of said first reaction mechanism and by way of a second reaction mechanism has an aromatic backbone and a plurality of epoxy and/or allyl reactive groups thereon. Exemplary reactive monomer(s) which is(are) initiated both by way of said first reaction mechanism and by way of a second reaction mechanism have one or more epoxy functionalities and one or more allyl functionalities thereon. Examples of such reactive monomers are compounds having the structure:

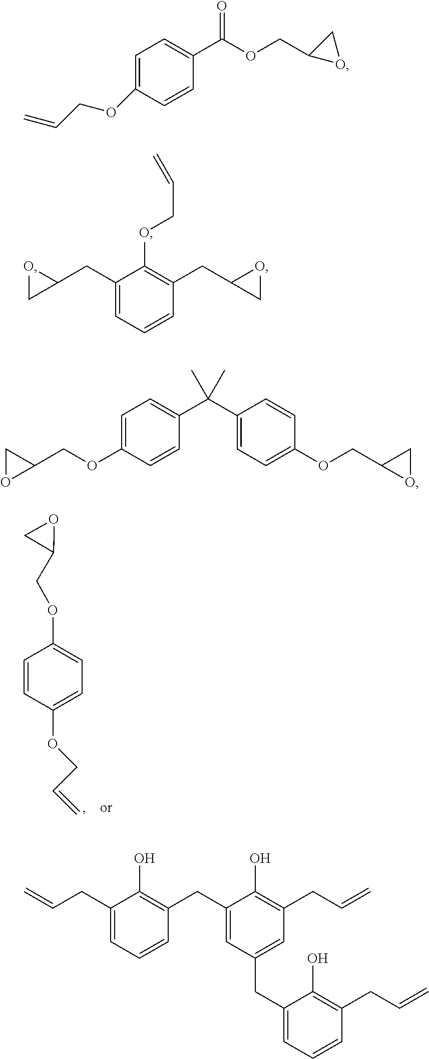 [SMILES: C=CCOc1ccc(C(=O)OCC2CO2)cc1 ; C=CCOc1c(CC2CO2)cccc1CC1CO1 ; CC(C)(c1ccc(OCC2CO2)cc1)c1ccc(OCC2CO2)cc1 ; C=CCOc1ccc(OCC2CO2)cc1 ; C=CCc1cccc(Cc2cc(CC=C)c(O)c(Cc3cccc(CC=C)c3O)c2)c1O]

In some embodiments, formulations contemplated for use herein will contain one or more particulate fillers. Particulate fillers contemplated for use in the practice of the present invention may optionally be treated and typically have a particle size in the range of 10 nm to 100 μm.

Exemplary particulate fillers contemplated for use in the practice of the present invention include carbon black or an oxide, hydroxide, carbonate, nitride, or silicate of aluminum, boron, calcium, magnesium, silica, titanium, or the like, as well as mixtures of any two or more thereof.

When compositions according to the present invention contain filler, the resulting formulations typically comprise in the range of about 20-80 wt % of said particulate filler. In some embodiments, compositions according to the present invention comprise in the range of about 30-80 wt % of said particulate filler; in some embodiments, compositions according to the present invention comprise in the range of about 30-70 wt % of said particulate filler; in some embodiments, compositions according to the present invention comprise in the range of about 30-60 wt % of said particulate filler; in some embodiments, compositions according to the present invention comprise in the range of about 40-60 wt % of said particulate filler.

Invention compositions may also optionally comprise in the range of about 0.2-2 wt % of a free-radical polymerization initiator. In certain embodiments, invention compositions comprise in the range of about 0.2-1 wt % of a free radical polymerization initiator.

In some embodiments, resin formulations employed in the practice of the present invention further comprise one or more flow additives, adhesion promoters, rheology modifiers, toughening agents, fluxing agents, film flexibilizers, phenolic hardeners, co-reactants (e.g., acid dianhydride, diamines or diphenol oligomers), epoxy-curing catalysts (e.g., imidazole), curing agents (e.g., dicumyl peroxide), flame retardant materials, colorants, processing aids, radical stabilizers, and the like, as well as mixtures of any two or more thereof.

As used herein, the term “flow additives” refers to compounds which modify the viscosity of the formulation to which they are introduced. Exemplary compounds which impart such properties include silicon polymers, ethyl acrylate/2-ethylhexyl acrylate copolymers, alkylol ammonium salts of phosphoric acid esters of ketoxime, and the like, as well as combinations of any two or more thereof.

As used herein, the term “adhesion promoters” refers to compounds which enhance the adhesive properties of the formulation to which they are introduced.

As used herein, the term “rheology modifiers” refers to additives which modify one or more physical properties of the formulation to which they are introduced.

As used herein, the term “toughening agents” refers to additives which enhance the impact resistance of the formulation to which they are introduced.

As used herein, the term “fluxing agents” refers to reducing agents which prevent oxides from forming on the surface of the molten metal.

As used herein, the term “film flexibilizer” refers to an additive that gives an otherwise rigid plastic flexibility. Such materials are also referred to in the art as plasticizers.

As used herein, the term “phenolic hardeners” refers to an ingredient of certain adhesives and synthetic resins that accelerates or promotes setting, wherein said material has a phenolic backbone.

As used herein, the term “co-reactants” refers to such reactive species as acid dianhydrides, diamines, diphenol oligomers, and the like.

As used herein, the term “epoxy-curing catalysts” refer to amines, imidazoles, anhydrides, and the like. Epoxy curing catalysts are also referred to in the art as “curing agents” (e.g., dicumyl peroxide).

As used herein, the term “flame retardant materials” refers to a function, not a family of chemicals. A variety of different chemicals, with different properties and structures, act as flame retardants and these chemicals are often combined for effectiveness. Elements such as bromine, phosphorus, nitrogen and chlorine are commonly present in compounds having flame retardant activity. Inorganic compounds are also used in flame retardants, either alone or as part of a flame retardant system in conjunction with compounds having one or more of bromine, phosphorus or nitrogen.

As used herein, the term “colorants” refers to is something added to something else to cause a change in color. Colorants can be dyes, pigments, biological pigments, inks, paints, coloured chemicals, food colorings, and the like.

As used herein, the term “processing aids” refers to materials used to improve the processability of polymeric formulations, especially high molecular polymers.

As used herein, the term “radical stabilizers” refers to compounds such as hydroquinones, benzoquinones, hindered phenols, benzotriazole-based ultraviolet absorbers, triazine-based ultraviolet absorbers, benzophenone-based ultraviolet absorbers, benzoate-based ultraviolet absorbers, hindered amine-based ultraviolet absorbers, and the like, as well as combinations of any two or more thereof.

When present, invention compositions comprise in the range of about 0.1-1 wt % of said radical stabilizer. In some embodiments, invention compositions comprise in the range of about 0.1-0.6 wt % of said radical stabilizer.

Invention compositions may also optionally contain one or more diluents. When diluent is present, invention compositions comprise in the range of about 10-50 wt % diluent, relative to the total composition. In certain embodiments, invention compositions comprise in the range of about 20-40 wt % diluent.

Exemplary diluents contemplated for use herein, when present, include aromatic hydrocarbons (e.g., benzene, toluene, xylene, and the like), saturated hydrocarbons (e.g., hexane, cyclohexane, heptane, tetradecane), chlorinated hydrocarbons (e.g., methylene chloride, chloroform, carbon tetrachloride, dichloroethane, trichloroethylene, and the like), ethers (e.g., diethyl ether, tetrahydrofuran, dioxane, glycol ethers, monoalkyl or dialkyl ethers of ethylene glycol, and the like), polyols (e.g., polyethylene glycol, propylene glycol, polypropylene glycol, and the like), esters (e.g., ethyl acetate, butyl acetate, methoxy propyl acetate, and the like); dibasic esters, alpha-terpineol, beta-terpineol, kerosene, dibutylphthalate, butyl carbitol, butyl carbitol acetate, carbitol acetate, ethyl carbitol acetate, hexylene glycol, high boiling alcohols and esters thereof, glycol ethers, ketones (e.g., acetone, methyl ethyl ketone, and the like), amides (e.g., dimethylformamide, dimethylacetamide, and the like), heteroaromatic compounds (e.g., N-methylpyrrolidone, and the like), and the like, as well as mixtures of any two or more thereof.

In accordance with another embodiment of the present invention, there are provided methods to maintain the tensile strength of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

As used herein, “thermal cycling” refers to alternating exposure to temperatures as low as −50° C. (or lower) and as high as +200° C., or even +225° C. (or higher). In some embodiments, “thermal cycling” refers to alternating exposure to temperatures as low as −40° C. and as high as +220° C.; in some embodiments, “thermal cycling” refers to alternating exposure to temperatures as low as −30° C. and as high as +200° C.; in some embodiments, “thermal cycling” refers to alternating exposure to temperatures as low as −20° C. and as high as +200° C. Such conditions demand a product with excellent tensile strength, especially where such tensile strength is substantially maintained in spite of exposure to thermal cycling.

In accordance with yet another embodiment of the present invention, there are provided methods to maintain the adhesion properties of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

In accordance with yet another embodiment of the present invention, there are provided methods to minimize weight loss of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

In accordance with yet another embodiment of the present invention, there are provided methods to maintain a substantially constant weight in a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

In accordance with yet another embodiment of the present invention, there are provided methods to maintain the dielectric strength of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

In accordance with yet another embodiment of the present invention, there are provided thermally stable thermoset polymer resins comprising a cured combination of:
one or more reactive monomer(s) which is(are) initiated by way of a first reaction mechanism at a temperature in the range of 40-200° C., and
one or more reactive monomer(s) which is(are) initiated both by way of said first reaction mechanism and by way of a second reaction mechanism that does not reach substantial levels of activation until said resin is exposed to an elevated temperature.

Thermally stable thermoset polymer resins contemplated herein are typically stable to exposure to elevated temperatures of at least 220° C. for at least 1000 hours. In some embodiments, thermoset polymer resins contemplated herein are typically stable to exposure to elevated temperatures of at least 230° C. for at least 1000 hours; in some embodiments, thermoset polymer resins contemplated herein are typically stable to exposure to elevated temperatures of at least 240° C. for at least 1000 hours; in some embodiments, thermoset polymer resins contemplated herein are typically stable to exposure to elevated temperatures of at least 250° C. for at least 1000 hours; in some embodiments, thermoset polymer resins contemplated herein are typically stable to exposure to elevated temperatures of at least 260° C. for at least 1000 hours.

As used herein, “stable” indicates that less than 50% degradation of one or more of the physical properties thereof occurs upon exposure to elevated temperatures over an extended period of time. In some embodiments, less than 40% degradation of one or more of the physical properties thereof occurs upon exposure to elevated temperatures over an extended period of time; in some embodiments, less than 30% degradation of one or more of the physical properties thereof occurs upon exposure to elevated temperatures over an extended period of time; in some embodiments, less than 20% degradation of one or more of the physical properties thereof occurs upon exposure to elevated temperatures over an extended period of time; in some embodiments, less than 10% degradation of one or more of the physical properties thereof occurs upon exposure to elevated temperatures over an extended period of time.

A wide variety of substrates are contemplated for use herein, e.g., a ceramic layer, optionally having a metallic finish thereon.

Suitable components contemplated for use herein include bare dies, eg. metal-oxide-semiconductor field-effect transistors (MOSFET), insulated-gate bipolar transistors (IGBT), diodes, light emitting diodes (LED), and the like.

In accordance with yet another embodiment of the present invention, there are provided thermally stable thermoset polymer resins prepared from a composition comprising:
at least 10 wt % of said reactive monomer(s) which is(are) initiated by way of said first reaction mechanism, and
at least 15 wt % of said reactive monomer(s) which is(are) initiated both by way of said first reaction mechanism and by way of a second reaction mechanism that does not reach substantial levels of activation until said resin is exposed to an elevated temperature.

In some embodiments, compositions employed in invention methods comprise at least 10 wt % of said reactive monomer(s) which is(are) initiated by way of said first reaction mechanism, and at least 20 wt % of said reactive monomer(s) which can be initiated by dual curing mechanisms; in some embodiments, compositions employed in invention methods comprise at least 10 wt % of said reactive monomer(s) which is(are) initiated by way of said first reaction mechanism, and at least 30 wt % of said reactive monomer(s) which can be initiated by dual curing mechanisms; in some embodiments, compositions employed in invention methods comprise at least 10 wt % of said reactive monomer(s) which is(are) initiated by way of said first reaction mechanism, and at least 40 wt % of said reactive monomer(s) which can be initiated by dual curing mechanisms; in some embodiments, compositions employed in invention methods comprise at least 10 wt % of said reactive monomer(s) which is(are) initiated by way of said first reaction mechanism, and at least 50 wt % of said reactive monomer(s) which can be initiated by dual curing mechanisms; in some embodiments, compositions employed in invention methods comprise at least 15 wt % of said reactive monomer(s) which is(are) initiated by way of said first reaction mechanism, and at least 20 wt % of said reactive monomer(s) which can be initiated by dual curing mechanisms; in some embodiments, compositions employed in invention methods comprise at least 15 wt % of said reactive monomer(s) which is(are) initiated by way of said first reaction mechanism, and at least 30 wt % of said reactive monomer(s) which can be initiated by dual curing mechanisms; in some embodiments, compositions employed in invention methods comprise at least 15 wt % of said reactive monomer(s) which is(are) initiated by way of said first reaction mechanism, and at least 40 wt % of said reactive monomer(s) which can be initiated by dual curing mechanisms; in some embodiments, compositions employed in invention methods comprise at least 15 wt % of said reactive monomer(s) which is(are) initiated by way of said first reaction mechanism, and at least 50 wt % of said reactive monomer(s) which can be initiated by dual curing mechanisms; in some embodiments, compositions employed in invention methods comprise at least 20 wt % of said reactive monomer(s) which is(are) initiated by way of said first reaction mechanism, and at least 20 wt % of said reactive monomer(s) which can be initiated by dual curing mechanisms; in some embodiments, compositions employed in invention methods comprise at least 20 wt % of said reactive monomer(s) which is(are) initiated by way of said first reaction mechanism, and at least 30 wt % of said reactive monomer(s) which can be initiated by dual curing mechanisms; in some embodiments, compositions employed in invention methods comprise at least 20 wt % of said reactive monomer(s) which is(are) initiated by way of said first reaction mechanism, and at least 40 wt % of said reactive monomer(s) which can be initiated by dual curing mechanisms; in some embodiments, compositions employed in invention methods comprise at least 20 wt % of said reactive monomer(s) which is(are) initiated by way of said first reaction mechanism, and at least 50 wt % of said reactive monomer(s) which can be initiated by dual curing mechanisms; in some embodiments, compositions employed in invention methods comprise at least 30 wt % of said reactive monomer(s) which is(are) initiated by way of said first reaction mechanism, and at least 20 wt % of said reactive monomer(s) which can be initiated by dual curing mechanisms; in some embodiments, compositions employed in invention methods comprise at least 30 wt % of said reactive monomer(s) which is(are) initiated by way of said first reaction mechanism, and at least 30 wt % of said reactive monomer(s) which can be initiated by dual curing mechanisms; in some embodiments, compositions employed in invention methods comprise at least 30 wt % of said reactive monomer(s) which is(are) initiated by way of said first reaction mechanism, and at least 40 wt % of said reactive monomer(s) which can be initiated by dual curing mechanisms; in some embodiments, compositions employed in invention methods comprise at least 30 wt % of said reactive monomer(s) which is(are) initiated by way of said first reaction mechanism, and at least 50 wt % of said reactive monomer(s) which can be initiated by dual curing mechanisms; in some embodiments, compositions employed in invention methods comprise at least 40 wt % of said reactive monomer(s) which is(are) initiated by way of said first reaction mechanism, and at least 20 wt % of said reactive monomer(s) which can be initiated by dual curing mechanisms; in some embodiments, compositions employed in invention methods comprise at least 40 wt % of said reactive monomer(s) which is(are) initiated by way of said first reaction mechanism, and at least 30 wt % of said reactive monomer(s) which can be initiated by dual curing mechanisms; in some embodiments, compositions employed in invention methods comprise at least 40 wt % of said reactive monomer(s) which is(are) initiated by way of said first reaction mechanism, and at least 40 wt % of said reactive monomer(s) which can be initiated by dual curing mechanisms; in some embodiments, compositions employed in invention methods comprise at least 50 wt % of said reactive monomer(s) which is(are) initiated by way of said first reaction mechanism, and at least 20 wt % of said reactive monomer(s) which can be initiated by dual curing mechanisms; in some embodiments, compositions employed in invention methods comprise at least 50 wt % of said reactive monomer(s) which is(are) initiated by way of said first reaction mechanism, and at least 30 wt % of said reactive monomer(s) which can be initiated by dual curing mechanisms; in some embodiments, compositions employed in invention methods comprise at least 50 wt % of said reactive monomer(s) which is(are) initiated by way of said first reaction mechanism, and at least 40 wt % of said reactive monomer(s) which can be initiated by dual curing mechanisms; in some embodiments.

In accordance with yet another embodiment of the present invention, there are provided thermally stabilized formulations comprising a cured composition comprising:
at least 10 wt % of said reactive monomer(s) which is(are) initiated by way of said first reaction mechanism, and
at least 15 wt % of said reactive monomer(s) which is(are) initiated both by way of said first reaction mechanism and by way of a second reaction mechanism that does not reach substantial levels of activation until said resin is exposed to an elevated temperature,
wherein said formulation is cured at a temperature in the range of about 40 up to 200° C.

In accordance with yet another embodiment of the present invention, there are provided epoxy resins which is(are) initiated at a temperature in the range of 40-200° C., wherein said epoxy resin further comprises one or more reactive functionalities which is(are) initiated at an elevated temperature.

In accordance with yet another embodiment of the present invention, there are provided acrylate resins which is(are) initiated at a temperature in the range of 40-200° C., wherein said acrylate resin further comprises one or more reactive functionalities which is(are) initiated at an elevated temperature.

In accordance with yet another embodiment of the present invention, there are provided benzoxazole resins which is(are) initiated at a temperature in the range of 40-200° C., wherein said benzoxazole further comprises one or more reactive functionalities which is(are) initiated at an elevated temperature.

In accordance with yet another embodiment of the present invention, there are provided articles comprising a first component bonded to a second component by a cured aliquot of a formulation according to the present invention.

Various aspects of the present invention are illustrated by the following non-limiting examples. The examples are for illustrative purposes and are not a limitation on any practice of the present invention. It will be understood that variations and modifications can be made without departing from the spirit and scope of the invention. One of ordinary skill in the art readily knows how to synthesize or commercially obtain the reagents and components described herein.

### Example 1

The physical properties of a commercially available epoxy material (Henkel product ES0515, a traditional epoxy-based potting material for high temperature applications) were studied after being subjected to thermal aging at 200° C. for 1000 hours. The results are summarized in Table 1.

TABLE 1
Control study: Henkel commercial product ES0515

| | | After | After | |
|---|---|---|---|---|
| | Before | thermal | thermal | Percentage |
| | thermal | aging | aging | of |
| Physical | aging | (240° C. for | (240° C. for | degradation |
| Property | value | 500 hours) | 1000 hours) | (%) |
| Isothermal TGA | | | | −24% |
| weight loss (5 | | | | |
| hours @ 300° C.) | | | | |
| Adhesion | 2780 | 1300 | 890 | −68% |
| retention (Psi) | | | | |
| Tensile Strength | 67 | 44 | 23 | −65% |
| retention (Mpa) | | | | |

The results in Table 1 illustrate the rapid degradation of several important performance properties upon exposure of epoxy resins to thermal aging at 200° C. for 1000 hours.

### Example 2

An exemplary formulation was prepared containing epoxy (Araldite LY 1556 US), allyl-containing monomer (Rezicure 3700), epoxy-curing agent (MEHC 7800SS), allyl curing agent (Curezol 2E4MZ) and 50 wt % filler (MSR2000), as summarized in Table 2, below:

TABLE 2
CRE20953-51

| | |
|---|---|
| Araldite LY 1556 US | 27.23 |
| Rezicure 3700 | 14.89 |
| MEHC 7800SS | 7.38 |
| Curezol 2E4MZ | 0.5 |
| MSR2000 | 50 |
| Total | 100 |

The stability of the resulting formulation upon thermal aging was tested. Results are summarized in Table 3.

TABLE 3
Example 2: Material with stoichiometrical amount of
Rezicure 3700

| | | After | After | |
|---|---|---|---|---|
| | Before | thermal | thermal | Percentage |
| | thermal | aging | aging | of |
| Physical | aging | (250 C. for | (250 C. for | degradation |
| Property | value | 500 hours) | 1000 hours) | (%) |
| Isothermal TGA | | | | 12 |
| weight loss (5 | | | | |
| hours @ 300 C.) | | | | |
| Adhesion | 3569 | 1959 | 1759 | −51% |
| retention (Psi) | | | | |
| Tensile Strength | 63 | 44 | 43 | −32% |
| retention (Mpa) | | | | |

The results set forth above demonstrate that weight loss, adhesion retention and tensile strength retention are improved by the addition of material which undergoes polymerization via a different cure mechanism than the ester component.

### Example 3

An additional formulation was prepared and evaluated. See Table 4 for detail regarding the formulation, and Table 5 for the results:

TABLE 4
CRE20953-61

| | |
|---|---|
| Araldite LY 1556 US | 25.68 |
| Rezicure 3700 | 16.87 |
| MEHC 7800SS | 6.97 |
| Curezol 2E4MZ | 0.48 |
| MSR2000 | 50 |
| Total | 100 |

The stability of the resulting formulation upon thermal aging was tested. Results are summarized in Table 5.

TABLE 5
Example 3: Material with 20% excess amount of
Rezicure 3700 than stoichiometry

| | | After | After | |
|---|---|---|---|---|
| | Before | thermal | thermal | Percentage |
| | thermal | aging | aging | of |
| Physical | aging | (250 C. for | (250 C. for | degradation |
| Property | value | 500 hours) | 1000 hours) | (%) |
| Isothermal TGA | | | | −8% |
| weight loss (5 | | | | |
| hours @ 300 C.) | | | | |
| Adhesion | 2827 | 1971 | 1954 | −31% |
| retention (Psi) | | | | |
| Tensile Strength | 34 | 37 | 38 | 11% |
| retention (Mpa) | | | | |

The results set forth above demonstrate that weight loss, adhesion retention and tensile strength retention are improved by the addition of an excess of material which undergoes polymerization via a different cure mechanism than the ester component.

### Example 4

An additional formulation was prepared and evaluated. See Table 6 for detail regarding the formulation, and Table 7 for the results:

TABLE 6
CRE20953-60

| | |
|---|---|
| Araldite LY 1556 US | 24.96 |
| Rezicure 3700 | 17.81 |
| MEHC 7800SS | 6.76 |
| Curezol 2E4MZ | 0.47 |
| MSR2000 | 50 |
| Total | 100 |

The stability of the resulting formulation upon thermal aging was tested. Results are summarized in Table 7.

TABLE 7
Example 4: Material with 30% excess amount of
Rezicure 3700 than stoichiometry

| | | After | After | |
|---|---|---|---|---|
| | Before | thermal | thermal | Percentage |
| | thermal | aging | aging | of |
| Physical | aging | (250 C. for | (250 C. for | degradation |
| Property | value | 500 hours) | 1000 hours) | (%) |
| Isothermal TGA | | | | −6% |
| weight loss (5 | | | | |
| hours @ 300 C.) | | | | |
| Adhesion | 1673 | 1881 | 1888 | 13% |
| retention (Psi) | | | | |
| Tensile Strength | 30 | 36.5 | 38 | 26% |
| retention (Mpa) | | | | |

The results set forth above demonstrate that weight loss, adhesion retention and tensile strength retention are improved by the addition of material which undergoes polymerization via a different cure mechanism than the ester component.

### Example 5

The thermal cycling performance of CRE20953-61 (see Example 3) and commercial Henkel product ES0515, was tested by subjecting the test materials to repeated thermal cycles between −40° C. and 150° C. The results are as follows.

Three out of three articles prepared with commercially available epoxy material cracked after 450 heat/cold cycles. Conversely, none of the articles prepared with CRE20953-61 (see Example 3) showed any signs of cracking, even after 1200 heat/cold cycles.

### NON-LIMITING LIST OF EXEMPLARY EMBODIMENTS

In addition to the aspects and embodiments described and provided elsewhere in this disclosure, the following non-limiting list of particular embodiments are specifically contemplated.

### Embodiment 1

A method to improve one or more performance properties of a thermoset polymer resin prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

Exemplary performance properties contemplated for improvement herein include:
thermal stability (which is enhanced by practicing invention methods);
tensile strength (which is maintained in spite of exposure to elevated temperatures over extended periods of time),
adhesive properties (which are substantially maintained in spite of exposure to elevated temperatures over extended periods of time),
weight loss (which is minimized in spite of exposure to elevated temperatures over extended periods of time),
dielectric strength (which is substantially maintained in spite of exposure to elevated temperatures over extended periods of time),
thermal cycle performance properties of thermoset resin materials upon exposure to elevated temperatures over extended periods of time,
and the like.

### Embodiment 2

The method of embodiment 1 wherein said elevated temperature comprises a temperature greater than 200° C.

### Embodiment 3

The method of any preceding embodiment wherein said one or more reactive monomer(s) which is(are) initiated by way of a first reaction mechanism at a temperature in the range of 40-200° C. is selected from an aromatic epoxy, a benzoxazine, an aromatic acrylate, an aromatic cyanate ester, an aromatic bismaleimide (BMI), an aromatic itaconamide, an aromatic nadimide, an aromatic ester, an aromatic olefin, an aromatic alkyne, an aromatic nitrile, as well as combinations of any two or more thereof.

### Embodiment 4

The method of embodiment 3 wherein said epoxy resin is prepared by the reaction of reactive monomers or oligomers of reaction products of aromatic phenols and epichlorohydrin.

### Embodiment 5

The method of embodiment 3 wherein said monomer is selected from liquid-type epoxies based on bisphenol A, solid-type epoxies based on bisphenol A, liquid-type epoxies based on bisphenol F (e.g., Epiclon EXA-835LV), multifunctional epoxies based on phenol-novolac resins, dicyclopentadiene-type epoxies (e.g., Epiclon HP-7200L), naphthalene-type epoxies, as well as mixtures of any two or more thereof.

### Embodiment 6

The method of embodiment 3 wherein said acrylate is selected from monofunctional (meth)acrylates, difunctional (meth)acrylates, trifunctional (meth)acrylates, or polyfunctional (meth)acrylates, as well as mixtures of any two or more thereof.

### Embodiment 7

The method of embodiment 3 wherein said benzoxazine has the structure:

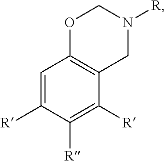

wherein:
R, R′ and R″ are each independently selected from hydrogen, substituted or unsubstituted alkyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl, as well as combinations of any two or more thereof.

### Embodiment 8

The method of embodiment 3 wherein said cyanate ester is an aryl compound having at least one cyanate ester group on each molecule and is represented by the formula:

Ar(OCN)ₘ,

where m is an integer from 2 to 5 and Ar is an aromatic moiety.

### Embodiment 9

The method of embodiment 8 wherein the aromatic moiety Ar contains at least 6 carbon atoms, and is derived from an aromatic hydrocarbon.

### Embodiment 10

The method of embodiment 8 wherein the aromatic moiety Ar is derived from a polynuclear aromatic hydrocarbon in which at least two aromatic rings are attached to each other through a bridging group.

### Embodiment 11

The method of embodiment 8 wherein the aromatic moieties are cyanate esters of novolac-type phenolic resins.

### Embodiment 12

The method of embodiment 8 wherein said cyanate ester is 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene or cyanated bisphenol-terminated polycarbonate or other thermoplastic oligomer.

### Embodiment 13

The method of embodiment 8 wherein said cyanate ester is AROCY 366 (1,3-bis[4-cyanatophenyl-1-(methylethylidene)]benzene),

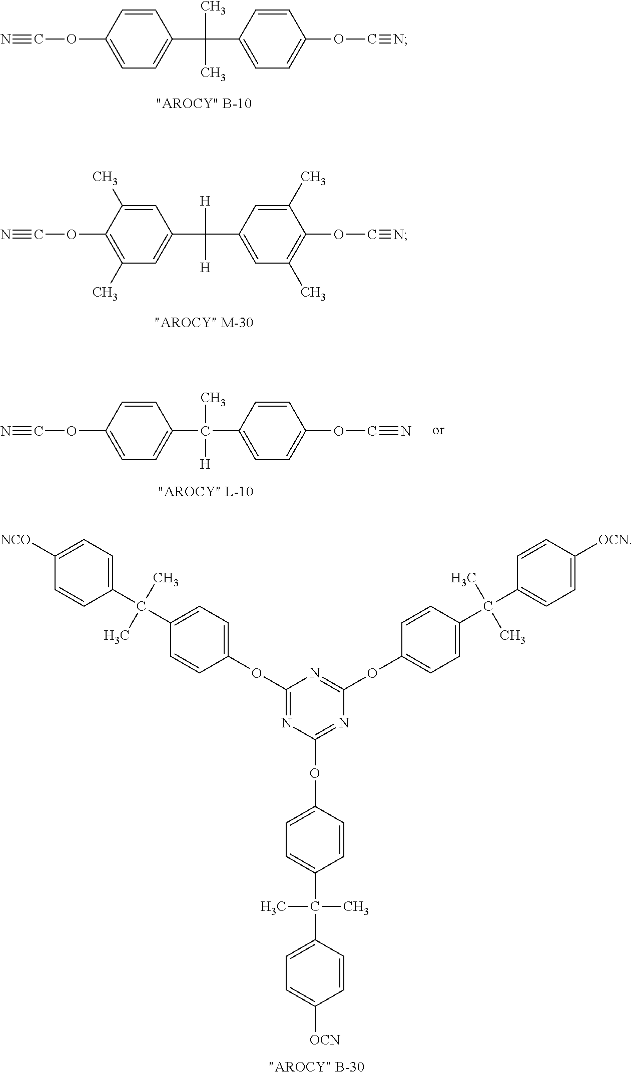

### Embodiment 14

The method of embodiment 3 wherein said bismaleimide (BMI), itaconamide or nadimide has the structure:

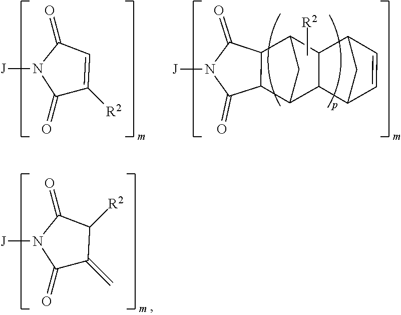

respectively, wherein:
m is 1-15,
p is 0-15,
each R² is independently selected from hydrogen or lower alkyl (such as C₁₋₅), and
J is a monovalent or a polyvalent moiety comprising organic or organosiloxane moieties, and
combinations of any two or more thereof.

### Embodiment 15

The method of embodiment 14 wherein J is a monovalent or polyvalent moiety selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as
   combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

### Embodiment 16

The method of embodiment 14 wherein J is oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl. oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, amino arylalkynylene, carboxy arylalkynylene, oxyalkynylarylene, thioalkynylarylene, amino alkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

### Embodiment 17

The method of embodiment 3 wherein said ester is monobasic (e.g., ethyl acetate, butyl acetate, methoxy propyl acetate, and the like); a dibasic ester (e.g., alpha-terpineol, beta-terpineol, kerosene, dibutylphthalate, and the like), butyl carbitol, butyl carbitol acetate, carbitol acetate, ethyl carbitol acetate, hexylene glycol, or an ester of a high boiling alcohol.

### Embodiment 18

The method of embodiment 3 wherein said olefin has the structure:

R¹(R²)C═CR³(R⁴)

wherein each of R¹, R², R³ and R⁴ are independently hydrogen, substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

### Embodiment 19

The method of embodiment 18 wherein said olefin is ethylene, propylene, 1-butene, 1-hexene, 3-methyl-1-pentene, or 4-methyl-1-pentene or a polymerizable hydrophobic aromatic hydrocarbon such as styrene.

### Embodiment 20

The method of embodiment 3 wherein said nitrile has the structure:

R¹C≡N

wherein R¹ is substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

### Embodiment 21

The method of embodiment 3 wherein the alkynes contemplated for use herein have the structure:

R¹C≡CR³

wherein each of R¹ and R³ are independently hydrogen, substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

### Embodiment 22

The method of any of the preceding embodiments wherein said resin further comprises a filler.

### Embodiment 23

The method of embodiment 22 wherein said filler is optionally treated and has a particle size in the range of 10 nm to 10 μm.

### Embodiment 24

The method of embodiment 23 wherein said filler is carbon black or an oxide, hydroxide, carbonate, nitride, or silicate of aluminum, boron, calcium, magnesium, silica, titanium, as well as mixtures of any two or more thereof.

### Embodiment 25

The method of embodiment 1 wherein said resin further comprises one or more flow additives, adhesion promoters, rheology modifiers, toughening agents, fluxing agents, film flexibilizers, phenolic hardeners, co-reactants (e.g., acid dianhydride, diamines or diphenol oligomers), epoxy-curing catalysts (e.g., imidazole), curing agents (e.g., dicumyl peroxide), flame retardant materials, colorants, processing aids, radical stabilizers, as well as mixtures of any two or more thereof.

### Embodiment 26

The method of embodiment 1 wherein at least one reactive group of said one or more reactive monomer(s) which is(are) initiated both by way of said first reaction mechanism and by way of a second reaction mechanism is an allyl group.

### Embodiment 27

The method of embodiment 1 wherein said one or more reactive monomer(s) which is(are) initiated both by way of said first reaction mechanism and by way of a second reaction mechanism has an aromatic backbone and a plurality of epoxy and/or allyl reactive groups thereon.

### Embodiment 28

The method of any of the preceding embodiments, wherein said one or more reactive monomer(s) which is(are) initiated both by way of said first reaction mechanism and by way of a second reaction mechanism has the structure:

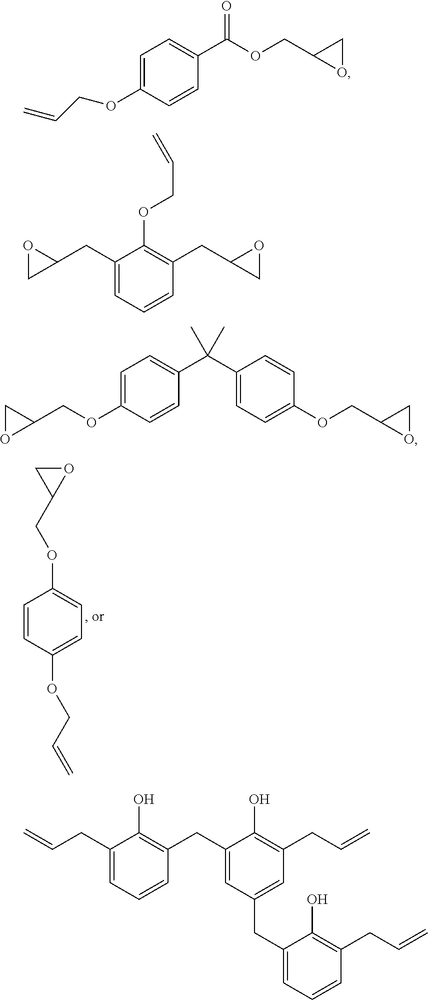

Various modifications of the present invention, in addition to those shown and described herein, will be apparent to those skilled in the art of the above description. Such modifications are also intended to fall within the scope of the appended claims.

Patents and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

That which is claimed is:

1. A method to improve the thermal stability of a thermoset polymer resin prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature greater than 200° C.

2. The method of claim 1 wherein said one or more reactive monomer(s) which is(are) initiated by way of a first reaction mechanism at a temperature in the range of 40-200° C. is selected from compounds having one or more aromatic epoxy groups thereon, one or more benzoxazine groups thereon, one or more aromatic acrylate groups thereon, one or more aromatic cyanate ester groups thereon, one or more aromatic bismaleimide (BMI) groups thereon, one or more aromatic itaconamide groups thereon, one or more aromatic nadimide groups thereon, one or more aromatic ester groups thereon, one or more aromatic olefin groups thereon, one or more aromatic alkyne groups thereon, or one or more aromatic nitrile groups thereon, as well as compounds having combinations of any two or more of said reactive groups thereon, or combinations of any two or more of said reactive monomers.

3. The method of claim 2 wherein said one or more reactive monomer(s) is an epoxy monomer.

4. The method of claim 3 wherein said epoxy monomer is a reactive monomer or oligomer of reaction products of aromatic phenols and epichlorohydrin.

5. The method of claim 3 wherein said epoxy monomer is selected from liquid-type epoxies based on bisphenol A, solid-type epoxies based on bisphenol A, liquid-type epoxies based on bisphenol F, multifunctional epoxies based on phenol-novolac resins, dicyclopentadiene-type epoxies, naphthalene-type epoxies, as well as mixtures of any two or more thereof.

6. The method of claim 2 wherein said aromatic acrylate is selected from monofunctional (meth)acrylates, difunctional (meth)acrylates, trifunctional (meth)acrylates, or polyfunctional (meth)acrylates, as well as mixtures of any two or more thereof.

7. The method of claim 2 wherein said benzoxazine has the structure: 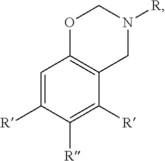
wherein:
R, R′ and R″ are each independently selected from hydrogen, substituted or unsubstituted alkyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl, as well as combinations of any two or more thereof.

8. The method of claim 2 wherein said cyanate ester is an aryl compound having at least one cyanate ester group on each molecule and is represented by the formula:
Ar(OCN)ₘ,
where m is an integer from 2 to 5 and Ar is an aromatic moiety.

9. The method of claim 8 wherein the aromatic moiety Ar contains at least 6 carbon atoms, and is derived from an aromatic hydrocarbon.

10. The method of claim 8 wherein the aromatic moiety Ar is derived from a polynuclear aromatic hydrocarbon in which at least two aromatic rings are attached to each other through a bridging group.

11. The method of claim 8 wherein the aromatic moieties are cyanate esters of novolac-type phenolic resins.

12. The method of claim 8 wherein said cyanate ester is 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane and 3,3′,5,5′-tetramethyl bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; 1,3-bis[4-cyanatophenyl-1-(methylethylidene)]benzene or cyanated bisphenol-terminated polycarbonate or other thermoplastic oligomer.

13. The method of claim 8 wherein said cyanate ester is AROCY 366 (1,3-bis[4-cyanatophenyl-1-(methylethylidene)]benzene),

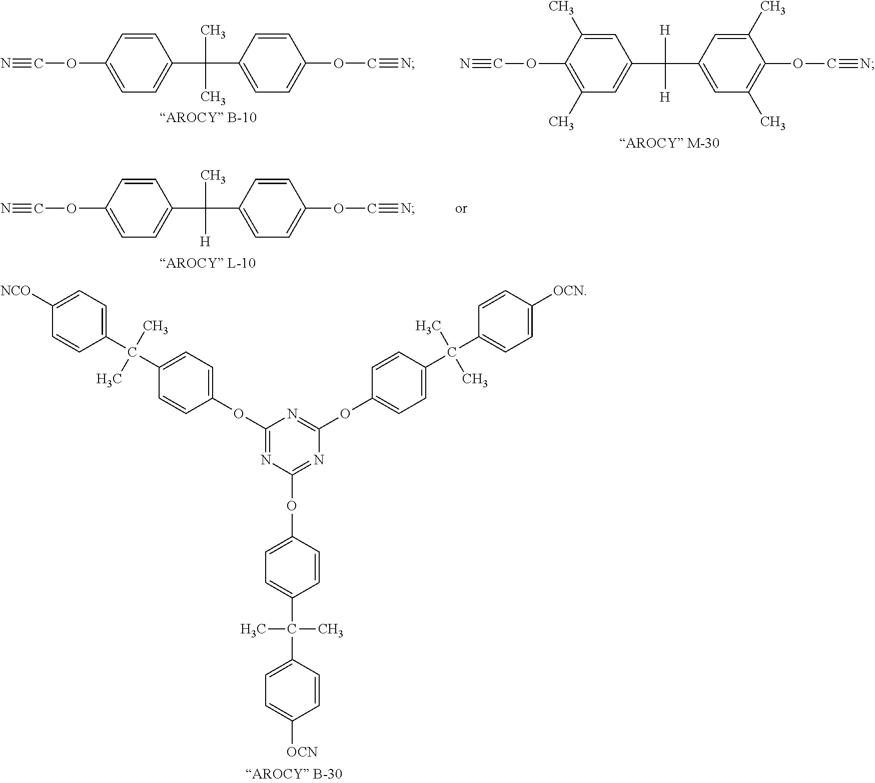

14. The method of claim 2 wherein said bismaleimide (BMI), itaconamide or nadimide has the structure: 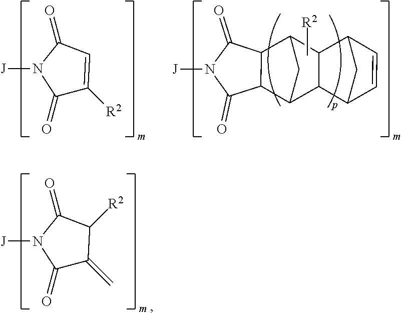
respectively, wherein:
m is 1-15,
p is 0-15,
each R² is independently selected from hydrogen or lower alkyl (such as C₁₋₅), and
J is a monovalent or a polyvalent moiety comprising organic or organosiloxane moieties, and
combinations of any two or more thereof.

15. The method of claim 14 wherein J is a monovalent or polyvalent moiety selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as
combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

16. The method of claim 14 wherein J is oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl. oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, amino alkenylarylene, carboxyalkenylarylene, oxyarylalkynylene, thioarylalkynylene, amino arylalkynylene, carboxy arylalkynylene, oxyalkynylarylene, thioalkynylarylene, amino alkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

17. The method of claim 2 wherein said ester is monobasic (e.g., ethyl acetate, butyl acetate, methoxy propyl acetate, and the like); a dibasic ester (e.g., alpha-terpineol, beta-terpineol, kerosene, dibutylphthalate, and the like), butyl carbitol, butyl carbitol acetate, carbitol acetate, ethyl carbitol acetate, hexylene glycol, or an ester of a high boiling alcohol.

18. The method of claim 2 wherein said compound having one or more olefinic group thereon has the structure:
R¹(R²)C═CR³(R⁴)
wherein each of R², R³ and R⁴ are independently hydrogen, substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

19. The method of claim 18 wherein said olefin is ethylene, propylene, 1-butene, 1-hexene, 3-methyl-1-pentene, or 4-methyl-1-pentene or a polymerizable hydrophobic aromatic hydrocarbon such as styrene.

20. The method of claim 2 wherein said compounds having one or more aromatic nitrile groups thereon have the structure:
R¹C≡N
wherein R¹ is substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

21. The method of claim 2 wherein said compound having one or more aromatic alkyne groups have the structure:
R¹C≡CR³
wherein each of R¹ and R³ are independently hydrogen, substituted or unsubstituted alkyl, substituted or unsubstituted alkenyl, substituted or unsubstituted alkynyl, substituted or unsubstituted cycloalkyl, substituted or unsubstituted heterocycloalkyl, substituted or unsubstituted aryl, substituted or unsubstituted heteroaryl, substituted or unsubstituted aralkyl, substituted or unsubstituted heteroaralkyl, substituted or unsubstituted alkoxy, substituted or unsubstituted hydroxyl, substituted or unsubstituted hydroxyalkyl, substituted or unsubstituted carboxyl, halo, substituted or unsubstituted haloalkyl, substituted or unsubstituted amino, substituted or unsubstituted aminoalkyl, substituted or unsubstituted alkylcarbonyloxy, substituted or unsubstituted alkoxycarbonyl, substituted or unsubstituted alkylcarbonyl, substituted or unsubstituted alkylcarbonylamino, substituted or unsubstituted aminocarbonyl, substituted or unsubstituted alkylsulfonylamino, substituted or unsubstituted aminosulfonyl, substituted or unsubstituted sulfonic acid, or substituted or unsubstituted alkylsulfonyl.

22. The method of claim 21 wherein said resin further comprises a filler.

23. The method of claim 22 wherein said filler is optionally treated and has a particle size in the range of 10 nm to 100 μm.

24. The method of claim 22 wherein said filler is carbon black or an oxide, hydroxide, carbonate, nitride, or silicate of aluminum, boron, calcium, magnesium, silica, titanium, as well as mixtures of any two or more thereof.

25. The method of claim 1 wherein said resin further comprises one or more flow additives, adhesion promoters, rheology modifiers, toughening agents, fluxing agents, film flexibilizers, phenolic hardeners, co-reactants (e.g., acid dianhydride, diamines or diphenol oligomers), epoxy-curing catalysts (e.g., imidazole), curing agents (e.g., dicumyl peroxide), flame retardant materials, colorants, processing aids, radical stabilizers, as well as mixtures of any two or more thereof.

26. The method of claim 25 wherein at least one reactive group of said one or more reactive monomer(s) which is(are) initiated both by way of said first reaction mechanism and by way of a second reaction mechanism is an allyl group, a nitrile group or an alkynyl group.

27. The method of claim 1 wherein said one or more reactive monomer(s) which is(are) initiated both by way of said first reaction mechanism and by way of a second reaction mechanism has an aromatic backbone and a plurality of epoxy and/or allyl reactive groups thereon.

28. The method of claim 27, wherein said one or more reactive monomer(s) which is(are) initiated both by way of said first reaction mechanism and by way of a second reaction mechanism have one or more epoxy functionalities and/or one or more allyl functionalities thereon.

29. The method of claim 28 wherein said reactive monomer has the structure:

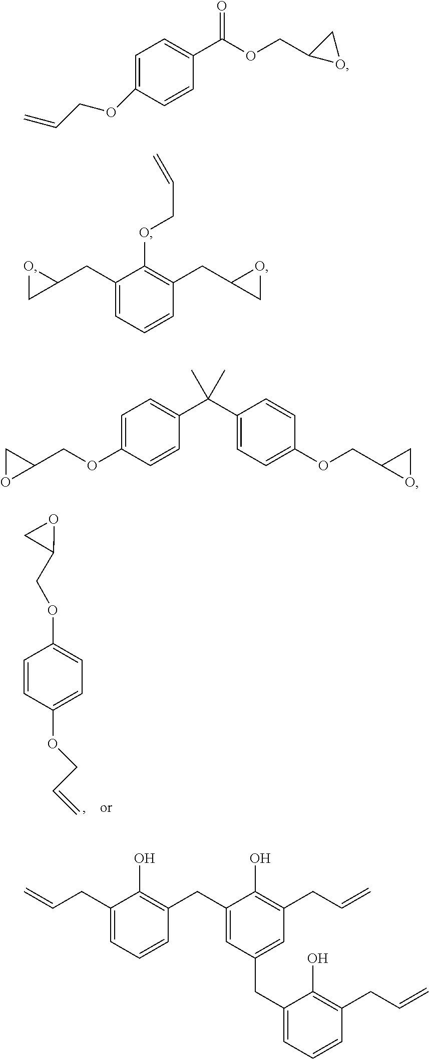 [SMILES: C=CCOc1ccc(C(=O)OCC2CO2)cc1 ; C=CCOc1c(CC2CO2)cccc1CC1CO1 ; CC(C)(c1ccc(OCC2CO2)cc1)c1ccc(OCC2CO2)cc1 ; C=CCOc1ccc(OCC2CO2)cc1 ; C=CCc1cccc(Cc2cc(CC=C)c(O)c(Cc3cccc(CC=C)c3O)c2)c1O]

30. A method to maintain the tensile strength of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

31. A method to maintain the adhesion properties of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

32. A method to minimize weight loss of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

33. A method to maintain a substantially constant weight in a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

34. A method to maintain the dielectric strength of a thermoset polymer resin upon exposure to elevated temperatures and/or exposure to thermal cycling conditions between high and low temperatures, wherein said thermoset polymer resin is prepared by the activation of one or more reactive monomer(s) which is(are) initiated by way of a first reaction mechanism at a temperature in the range of 40-200° C., said method comprising employing as at least a portion of said reactive monomer(s) one or more reactive monomer(s) which is(are) initiated both by way of said first reaction mechanism and by way of a second reaction mechanism that does not reach substantial levels of activation until said resin is exposed to an elevated temperature.

35. A thermally stable thermoset polymer resin comprising a cured combination of:
one or more reactive monomer(s) which is(are) initiated by way of a first reaction mechanism at a temperature in the range of 40-200° C., and
one or more reactive monomer(s) which is(are) initiated both by way of said first reaction mechanism and by way of a second reaction mechanism that does not reach substantial levels of activation until said resin is exposed to an elevated temperature.

36. The thermally stable thermoset polymer resin of claim 35 wherein said resin is stable to exposure to elevated temperatures of at least 220° C. for at least 1000 hours.

37. The thermally stable thermoset polymer resin of claim 35 wherein said resin is prepared from a composition comprising:
at least 10 wt % of said reactive monomer(s) which is(are) initiated by way of said first reaction mechanism, and
at least 15 wt % of said reactive monomer(s) which is(are) initiated both by way of said first reaction mechanism and by way of a second reaction mechanism that does not reach substantial levels of activation until said resin is exposed to an elevated temperature.

38. A thermally stabilized formulation comprising a cured composition comprising:
at least 10 wt % of said reactive monomer(s) which is(are) initiated by way of said first reaction mechanism, and
at least 15 wt % of said reactive monomer(s) which is(are) initiated both by way of said first reaction mechanism and by way of a second reaction mechanism that does not reach substantial levels of activation until said resin is exposed to an elevated temperature,
wherein said formulation is cured at a temperature in the range of about 40 up to 200° C.

39. An epoxy resin which is(are) initiated at a temperature in the range of 40-200° C., wherein said epoxy resin further comprises one or more reactive functionality which is(are) initiated at an elevated temperature.

40. An acrylate resin which is(are) initiated at a temperature in the range of 40-200° C., wherein said acrylate further comprises one or more reactive functionalities which is(are) initiated at an elevated temperature.

41. A benzoxazole resin which is(are) initiated at a temperature in the range of 40-200° C., wherein said benzoxazole further comprises one or more reactive functionalities which is(are) initiated at an elevated temperature.

42. An article comprising a first component bonded to a second component by a cured aliquot of the formulation of claim 36.
